(19) United States
(12) Patent Application Publication
(10) Pub. No.: US 2018/0118632 A1
(43) Pub. Date: May 3, 2018

(54) PROCESS FOR MANUFACTURING FORMULATIONS OF CHELATING AGENTS

(71) Applicant: BASF SE, Ludwigshafen (DE)

(72) Inventors: Benjamin NEHLS, Ludwigshafen (DE); Markus KLUMPE, Mannheim (DE); Michael MAUSS, Neustadt (DE); Klaus ECKERT, Oberhausen-Rheinhausen (DE)

(73) Assignee: BASF SE, Ludwigshafen (DE)

(21) Appl. No.: 15/572,839

(22) PCT Filed: Apr. 19, 2016
(86) PCT No.: PCT/EP2016/058622

§ 371 Date: Nov. 9, 2017

(30) Foreign Application Priority Data
May 11, 2015 (EP) 15167068.4

(51) Int. Cl. C05D 9/02; C11D 3/33; C11D 3/43; C05D 9/00; C05G 3/00

(52) U.S. Cl. CPC C05D 9/02; C11D 3/33; C05G 3/0076; C05D 9/00; C11D 3/43

(57) ABSTRACT

Process for manufacturing a formulation of a chelating agent according to general formula (I): R¹—CH(COOX¹)—N(CH₂COOX¹)₂, wherein R¹ is selected from C₁-C₄-alkyl, linear or branched, phenyl, benzyl, CH₂OH, and CH₂CH₂COOX¹, X¹ is (MₓH₁₋ₓ), M being selected from alkali metal, x is in the range of from 0.6 to 1, said formulation comprising in the range of from 0.01 to 20% by weight of water, and at least one organic solvent selected from alkanols with a boiling point at normal pressure that is higher than the boiling point of water, from alkandiols, alkantriols and polyols and mixtures of at least two of the foregoing, said process comprising the following steps: (a) providing an aqueous solution of chelating agent according to general formula (I), (b) adding said organic solvent and (c) removing the water completely or the majority of the water by distillation.

The present invention relates to a process for manufacturing a formulation of a chelating agent according to general formula (I)

R¹—CH(COOX¹)—N(CH₂COOX¹)₂ (I)

wherein

R¹ is selected from C₁-C₄-alkyl, linear or branched, phenyl, benzyl, CH₂OH, and CH₂CH₂COOX¹,

X¹ is (MₓH₁₋ₓ), M being selected from alkali metal,

x is in the range of from 0.6 to 1,

said formulation comprising in the range of from 0.01 to 20% by weight of water, and at least one organic solvent selected from alkanols with a boiling point at normal pressure that is higher than the boiling point of water, from alkandiols, alkantriols and polyols and mixtures of at least two of the foregoing,

said process comprising the following steps:
(a) providing an aqueous solution of chelating agent according to general formula (I),
(b) adding said organic solvent and
(c) removing the water completely or the majority of the water by distillation.

Chelating agents such as methyl glycine diacetic acid (MGDA) and glutamic acid diacetic acid (GLDA) and their respective alkali metal salts are useful sequestrants for alkaline earth metal ions such as Ca²⁺ and Mg²⁺. For that reason, they are recommended and used for various purposes such as laundry detergents and for automatic dishwashing (ADW) formulations, in particular for so-called phosphate-free laundry detergents and phosphate-free ADW formulations. For shipping such chelating agents, in most cases either solids such as granules are being applied or aqueous solutions. Granules and powders are useful because the amount of water shipped can be neglected but for most mixing and formulation processes an extra dissolution step is required.

For several applications, however, neither granules nor powders nor aqueous solutions are desired. Some manufacturers of gel-type formulations rather wish to obtain gel-type pre-mixes that contain at least one chelating agent instead of manufacturing such pre-mix themselves.

In WO 2014/086504, a process for the manufacture of so-called low-in-water to water-free liquid detergent compositions has been disclosed. Said compositions contain at least one sulfonated polymer (“sulfopolymer”). The process includes the following steps: providing an aqueous solution of at least one sulfonated polymer together with an organic solvent, adding a builder such as tripolyphosphate, and stirring the mixture so obtained until the builder has dissolved completely.

The above process has the disadvantage in particular that often only slurries are obtained even after a long time of stirring, rather than translucent formulations that are solution-type in the ideal version. Such slurries are not desired because they appear optically unattractive in sales products.

It was therefore an objective to provide a method for making formulations that contain at least one environmentally friendly chelating agent, said process being easy to perform and yielding translucent formulations. It was another objective to provide further applications of such formulations.

Accordingly, the process defined at the outset has been found, hereinafter also being referred to as inventive process or process according to the (present) invention. The inventive process is a process for manufacturing a formulation of a chelating agent according to the general formula (I)

R¹—CH(COOX¹)—N(CH₂COOX¹)₂ (I)

wherein

R¹ is selected from
hydrogen,
C₁-C₄-alkyl, linear or branched, for example methyl, ethyl, n-propyl, iso-propyl, n-butyl, iso-butyl, sec.-butyl, preferred are methyl and iso-butyl and sec.-butyl and even more preferred is methyl,
phenyl, benzyl, CH₂OH, and CH₂CH₂COOX¹, preferred is CH₂CH₂COOX¹.

X¹ is (MₓH₁₋ₓ), M being selected from alkali metal, for example lithium, sodium or potassium or combinations of at least two of the foregoing, preferred are potassium and sodium and combinations of sodium and potassium, and sodium is even more preferred.

x is in the range of from 0.6 to 1, wherein x is an average value. Preferably, x is 1.

In a preferred embodiment, R¹ is methyl, x is 1, and X¹ is selected from potassium and sodium and combinations of sodium and potassium, and preference being given to sodium.

In one embodiment of the present invention, compound of general formula (I) is the racemic mixture. In other embodiments, compound of general formula (I) is selected from the pure enantiomers, for example the L-enantiomer, or mixtures of enantiomers in which one of the enantiomers prevails, preferably the L-enantiomer.

In one embodiment of the present invention, compound of general formula (I) is selected from mixtures of enantiomers containing predominantly the respective L-isomer with an enantiomeric excess (ee) in the range of from 3 to 97%, preferably 20 to 80% and even more preferably 25 to 75%. The enantiomeric excess can be determined by measuring the polarization (polarimetry) or preferably by chromatography, for example by HPLC with a chiral column, for example with one or more cyclodextrins as immobilized phase or with a ligand exchange (Pirkle-brush) concept chiral stationary phase. Preferred is determination of the ee by HPLC with an immobilized optically active amine such as D-penicillamine in the presence of copper(II) salt, especially for compounds according to general formula (I) with R¹ being methyl.

In one embodiment of the present invention, compound of general formula (I) may contain one or more impurities.

In one embodiment of the present invention, compound of general formula (I) may contain in the range of from 0.1 to 10% by weight of one or more optically inactive impurities, at least one of the impurities being selected from iminodiacetic acid, formic acid, glycolic acid, diglycolic acid, propionic acid, acetic acid and their respective alkali metal or mono-, di- or triammonium salts. In one aspect of the present invention, inventive mixtures may contain less than 0.2% by weight of nitrilotriacetic acid (NTA), preferably 0.01 to 0.1% by weight. The percentages are referring to the total weight of compound of general formula (I).

In one embodiment of the present invention, compound of general formula (I) may contain one or more optically active impurities. Examples of optically active impurities are L-carboxymethylalanine and its respective mono- or dialkali metal salts, and optically active mono- or diamides that result from an incomplete saponification of precursors during manufacture of compound of general formula (I). Preferably, the amount of optically active impurities is in the range of from 0.01 to 1.5% by weight, referring to the total solids content of compound of general formula (I). Even more preferred, the amount of optically active impurities is in the range of from 0.1 to 0.2% by weight.

In one aspect of the present invention, compound of general formula (I) may contain minor amounts of complexes of alkali earth metals or of transition metals. It is thus possible that minor amounts, such as 0.01 to 5 mol-% of compound of general formula (I), based on anion, bear alkali earth metal cations such as Mg²⁺ or Ca²⁺, or transition metal ions such as Fe²⁺ or Fe³⁺ cations.

Formulations comprising compound of general formula (I) contain in the range of from 0.01 to 20% by weight of water. Preference is given to 0.05 to 15% by weight of water. The water content may be determined, for example, by Karl-Fischer titration.

In addition, said formulations comprise at least one organic solvent selected from alkanols with a boiling point at normal pressure that is higher than the boiling point of water, from alkandiols, alkantriols and polyols and mixtures of at least two of the foregoing, preferred are alkandiols and alkantriols and mixtures of at least two of the foregoing, for examples a mixture of two alkandiols, or a mixture of one alkandiol and one alkantriol.

Organic solvents in the context of the present inventions are liquids at ambient temperature and normal pressure. In mixtures of at least two solvents, the respective mixture is liquid at ambient temperature and normal pressure.

Alkanols in the context of the present invention have a boiling point at normal pressure that is higher than the boiling point of water. Examples of suitable alkanols are n-butanol, 2-methyl-1-propanol, 1-pentanol, and 1-hexanol.

Examples of alkandiols are glycol, 1,2-propane diol, diethylene glycol, triethylenglycol, butan-1,2-diol, and 1,3-propandiol.

An example of alkantriols is glycerol.

In a preferred embodiment of the present invention, the at least one organic solvent is selected from ethylene glycol, 1,2-propane diol, glycerol, diethylene glycol, triethylene glycol, polyethylenglycol with an average molecular weight Mₙ of up to 400 g/mol, and polypropylenglycol with an average molecular weight Mₙ of up to 400 g/mol, and mixtures of at least two of the foregoing, for example mixtures from glycerol and at least one out of 1,2-propane diol, diethylene glycol and triethylene glycol.

In a preferred embodiment of the present invention the formulation comprising compound of general formula (I) contains more organic solvent than water. In the context of the present invention, the expression “more organic solvent than water” shall refer to the respective weight percentages.

The inventive process comprises the following steps, hereinafter also being referred to as step (a), step (b) or step (c), respectively.

(a) providing an aqueous solution of chelating agent according to general formula (I),

(b) adding said organic solvent and

(c) removing the water completely or the majority of the water by distillation.

Steps (a) to (c) shall be explained in more detail below.

Step (a) refers to providing an aqueous solution of chelating agent according to general formula (I). Said aqueous solution may contain in the range of from 20 to 60% by weight of chelating agent according to general formula (I), preferably 30 to 50% by weight, in particular 30 to 45% by weight, referring to the total aqueous solution. The aqueous solution provided in step (a) is transparent, that means, visible light may pass a 1 cm layer of such aqueous solution without being scattered. Such aqueous solution may be made by dissolving a powder or granule of chelating agent according to general formula (I) in water or in an aqueous solution of alkali metal hydroxide, or it may be provided as product of a synthesis of chelating agent according to general formula (I).

In step (b), a solvent selected from alkanols with a boiling point at normal pressure that is higher than the boiling point of water, from alkandiols, alkantriols and polyols and mixtures of at least two of the foregoing is added. Said addition may be performed in one or more portions, for example in two or three portions. Preferred is an addition of solvent in one portion.

In one embodiment of the present invention, step (b) is performed at ambient temperature. In other embodiments, step (b) is performed at a temperature higher than ambient temperature, for example at 22 to 50° C. In other embodiments, step (b) is performed at a temperature lower than ambient temperature, for example at zero to 18° C.

In one embodiment of the present invention, step (b) is performed by charging a vessel with solution from step (a) and then putting said organic solvent into such vessel. In other embodiments, a vessel is charged with an organic solvent followed by putting aqueous solution of step (a) into such vessel.

Step (b) may be accompanied by a mixing operation, for example by shaking or preferably stirring. In a preferred embodiment, step (b) is performed under stirring, for example under stirring with a speed in the range of from 20 to 400 rounds per minute.

In a preferred embodiment, the organic solvent selected in step (b) is glycerol, and stirring is performed with a speed in the range of from 20 to 100 rounds per minute.

In another preferred embodiment, the organic solvent selected in step (b) is ethylene glycol, 1,2-propandiol or an organic solvent with a similar viscosity, in particular ethylene glycol or 1,2-propandiol, and stirring is performed with a speed in the range of from 20 to 250 rounds per minute.

Examples of suitable means for stirring are anchor stirrers, ultra turrax stirrers, rotor-stator mixers, blade stirrers, propeller stirrers, and turbine stirrers.

After having performed step (b) a mixture is obtained.

In step (c), the water is removed completely or the majority of the water is removed. In each case, removal is performed by distillation. The term “distillation” in the context of step (c) of the present invention shall refer to methods for removal of water from the mixtures obtained from step (b) said methods involving partial or complete evaporation of the water but no or only a minor amount of the solvent added in step (b), for example up to 10% by weight, referring to the added solvent, preferably up to 5% by weight. Suitable methods include fractionated distillation, distillation under vacuum or under reduced pressure, removal of water in a column, a dividing wall column, a falling film evaporator or in a thin film evaporator. It is preferred to apply distillation under reduced pressure.

The temperature at which step (c) may be performed is in the range between 25 to 150° C., and it may depend on the organic solvent added in step (b) and on the pressure. It is possible to use a constant temperature or to employ an increase in temperature.

In one embodiment of the present invention, step (c) is performed at a temperature in the range of from 35 to 100° C. and a pressure in the range of from 5 to 100,000 hPa, in combination with any organic solvent or combination of solvents disclosed above.

Examples of preferred combinations of pressure and temperature are 25 to 60° C. at a pressure of 20 mbar or less and any of the aforementioned organic solvents, and 60 to 80° C. at a pressure of 50 to 80 mbar and ethylene glycol or diethylene glycol or 1,2-propanediol or glycerol as a solvent. In a special embodiment, a combination of 50 mbar and 80° C. is applied.

In embodiments wherein a falling film evaporator or a thin film evaporator is applied, the conditions may be 50 to 100° C. at 25 to 75 mbar, in combination with glycerol or ethylene glycol or 1,2-propylene glycol as solvent. Stirring, if applicable, may be in the range of from 25 to 100 rounds per minute.

In one embodiment of the present invention step (c) is carried out over a time of one to 5 hours.

Step (c) may be accompanied by a mixing operation, for example by shaking or preferably stirring. In a preferred embodiment, step (c) is performed under stirring, for example under stirring with a speed in the range of from 20 to 400 rounds per minute. In an even more preferred embodiment of the present invention, step (c) is accompanied by the same mixing operation as step (b) of the respective embodiment.

If stirring is too fast in step (c), air and/or inert gas may be dispersed in the organic solvent. Such dispersed air may be desirable in certain application but in most cases it is not.

Steps (b) and (c) of the inventive process may be carried out consecutively. In other embodiment, steps (b) and (c) are carried out simultaneously, or in a way that one portion of organic solvent is added before step (c) is commenced, and one or more additional portions of organic solvent may be added during step (c).

The inventive process may be carried out batch-wise or continuously, for example in a continuous stirred tank reactor that is simultaneously fed with solution according to step (a) and fed with organic solvent according to step (b) while water is being removed in accordance with step (c). During operation of said continuous stirred tank reactor, as an additional measure formulation of chelating agent according to general formula (I) in organic solvent is being removed.

In a special embodiment of the present invention, water may be removed by the way of an azeotropic distillation. In order to carry out such azeotropic distillation an entrainer is added before step (c), for example during step (b). During step (c), water and entrainer are distilled off and the condensate separated, for example in a Dean-Stark trap. Entrainer is then returned into the distillation vessel. At the end of the azeotropic distillation, the entrainer may be removed by evaporation.

Examples of suitable entrainers are ethanol, n-propanol, iso-propanol, n-butanol, sec-butanol, and tert.-butanol.

By performing steps (a) to (c) a formulation is being obtained. Such formulation is preferably transparent. In certain embodiments, it may contain bubbles of nitrogen or air which may be desired for certain applications such as for shampoos. In other embodiments, air bubbles are not desired, and said bubbles if any may be removed by stirring slowly, for example 25 to 100 rounds per minute, or heating to a temperature in the range from 50 to 100° C., preferably 85 to 95° C.

In one embodiment of the present invention, the inventive process is carried out without addition of further substances. In other embodiments, the inventive process includes the addition of at least one polymer or copolymer, and the formulation subsequently contains such polymer or copolymer. (Co)polymers in the context of the present invention shall have a molecular weight (M_{w}) of 1,000 g or more.

Examples of copolymers are polycarboxylates and polyaspartic acid, for example alkali metal salts of (meth)acrylic acid homopolymers or (meth)acrylic acid copolymers.

Suitable comonomers are monoethylenically unsaturated dicarboxylic acids such as maleic acid, fumaric acid, maleic anhydride, itaconic acid and citraconic acid. A suitable polymer is in particular polyacrylic acid, which preferably has an average molecular weight M_{w} in the range from 2000 to 40000 g/mol, preferably 2000 to 10000 g/mol, in particular 3000 to 8000 g/mol. Also of suitability are copolymeric polycarboxylates, in particular those of acrylic acid with methacrylic acid and of acrylic acid or methacrylic acid with maleic acid and/or fumaric acid, and in the same range of molecular weight.

It is also possible to select copolymers of at least one monomer from the group consisting of monoethylenically unsaturated C₃-C₁₀-mono- or C₄-C₁₀-dicarboxylic acids or anhydrides thereof, such as maleic acid, maleic anhydride, acrylic acid, methacrylic acid, fumaric acid, itaconic acid and citraconic acid, with at least one hydrophilic or hydrophobic monomer as listed below.

Suitable hydrophobic monomers are, for example, isobutene, diisobutene, butene, pentene, hexene and styrene, olefins with 10 or more carbon atoms or mixtures thereof, such as, for example, 1-decene, 1-dodecene, 1-tetradecene, 1-hexadecene, 1-octadecene, 1-eicosene, 1-docosene, 1-tetracosene and 1-hexacosene, C₂₂-α-olefin, a mixture of C₂₀-C₂₄-α-olefins and polyisobutene having on average 12 to 100 carbon atoms per molecule.

Suitable hydrophilic monomers are monomers with sulfonate or phosphonate groups, and also nonionic monomers with hydroxyl function or alkylene oxide groups. By way of example, mention may be made of: allyl alcohol, isoprenol, methoxypolyethylene glycol (meth)acrylate, methoxypolypropylene glycol (meth)acrylate, methoxypolybutylene glycol (meth)acrylate, methoxypoly(propylene oxide-co-ethylene oxide) (meth)acrylate, ethoxypolyethylene glycol (meth)acrylate, ethoxypolypropylene glycol (meth)acrylate, ethoxypolybutylene glycol (meth)acrylate and ethoxypoly(propylene oxide-co-ethylene oxide) (meth)acrylate. Polyalkylene glycols here may comprise 3 to 50, in particular 5 to 40 and especially 10 to 30 alkylene oxide units per molecule.

Particularly preferred sulfonic-acid-group-containing monomers here are 1-acrylamido-1-propanesulfonic acid, 2-acrylamido-2-propanesulfonic acid, 2-acrylamido-2-methylpropanesulfonic acid, 2-methacrylamido-2-methylpropanesulfonic acid, 3-methacrylamido-2-hydroxypropanesulfonic acid, allylsulfonic acid, methallylsulfonic acid, allyloxybenzenesulfonic acid, methallyloxybenzenesulfonic acid, 2-hydroxy-3-(2-propenyloxy)propanesulfonic acid, 2-methyl-2-propene-1-sulfonic acid, styrenesulfonic acid, vinylsulfonic acid, 3-sulfopropyl acrylate, 2-sulfoethyl methacrylate, 3-sulfopropyl methacrylate, sulfomethacrylamide, sulfomethylmethacrylamide, and salts of said acids, such as sodium, potassium or ammonium salts thereof.

Particularly preferred phosphonate-group-containing monomers are vinylphosphonic acid and its salts.

A further example of polymers is carboxymethyl inulin. Further examples are polyethylene-imines in which 20 to 90 mole-% of the N-atoms bear at least one —CH₂COO⁻ group, and the respective alkali metal salts.

In one embodiment of the present invention, a surfactant may be added before step (c). examples of suitable surfactants are anionic surfactants, cationic surfactants and especially non-ionic surfactants. Examples of preferred non-ionic surfactants are alkoxylated C₁₀-C₂₀-alkanols, especially ethoxylated or propoxylated C₁₀-C₂₀-alkanols, and C₄-C₁₆-alkyl polyglycosides. In order to mix formulations manufactured according to the inventive process it is possible to use at least one device selected from kneaders, extruders, stirrers, pumps, rotor-stator mixers, and sprayers. Examples of stirrers are anchor stirrers, ultra turrax stirrers, rotor-stator mixers, blade stirrers, propeller stirrers, and turbine stirrers.

Formulations manufactured according to the inventive process may advantageously be used for making cleaners, especially hard surface cleaners including automatic dishwashing formulations for industrial and institutional or home care applications, and for making laundry cleaning detergents.

In a special embodiment of the present invention, said formulation additionally contains 0.01 to 100 mol-% of at least one cation selected from Cu²⁺, Mn²⁺, Zn²⁺, Fe²⁺, Fe³⁺, Al³⁺, Cr³⁺, Co²⁺, Ni²⁺, Sn²⁺, Sn⁴⁺, Ti²⁺ and Ti⁴⁺ or a combination of at least two of the foregoing cations, the percentage referring to complexing agent according to general formula (I). Said cations are preferably present as complex of complexing agent according to general formula (I). Such content may be achieved by adding at least one salt of Cu²⁺, Mn²⁺, Zn²⁺, Fe²⁺, Fe³⁺, Al³⁺, Cr³⁺, Co²⁺, Ni²⁺, Sn²⁺, Sn⁴⁺, Ti²⁺ or Ti⁴⁺ during or after the synthesis of chelating agent according to general formula (I). Examples of suitable salts are the sulfates, carbonates, hydroxides, oxides, acetates, nitrates, and halides, especially the sulfates and the chlorides of the foregoing actions, including aquo complexes and base derivatives. Specific examples—under omission of aquo ligands—are CuSO₄, CuCl₂, Cu(acetate)₂, Cu(NO₃)₂, MnSO₄, MnCl₂, Mn(acetate)₂, Mn(NO₃)₂, CoSO₄, CoCl₂, Co(acetate)₂, Co(NO₃)₂, ZnSO₄, ZnCl₂, Zn(acetate)₂, Zn(NO₃)₂, FeSO₄, FeCl₂, Fe(acetate)₂, Fe(NO₃)₂, NiSO₄, NiCl₂, Ni(acetate)₂, Ni(NO₃)₂, TiOSO₄, Cr₂(SO₄)₃, CrCl₃, Cr(acetate)₃, Cr(NO₃)₃, Al₂(SO₄)₃, AlCl₃, Al(acetate)₃, Al(NO₃)₃, Fe₂(SO₄)₃, FeCl₃, Fe(acetate)₃, Fe(NO₃)₃, SnCl₂, SnO₂, and SnOCl₂.

Further examples are alums such as, but not limited to KAl(SO₄)₂.12H₂O, KCr(SO₄)₂.12H₂O, KTi(SO₄)₂.12H₂O, KMn(SO₄)₂.12H₂O, KFe(SO₄)₂.12H₂O, NaAl(SO₄)₂.12H₂O, NaCr(SO₄)₂.12H₂O, NaTi(SO₄)₂.12H₂O, NaMn(SO₄)₂.12H₂O, and NaFe(SO₄)₂.12H₂O.

It was found that such formulations are excellent micronutrients, especially if added to fertilizers.

A further aspect of the present invention therefore relates to formulations, hereinafter also being referred to as inventive formulations or formulations according to the present invention. Inventive formulations contain in the range of from 0.01 to 20% by weight, preferably 0.05 to 15% by weight, of water, and at least one organic solvent selected from alkanols, alkandiols, alkantriols and polyols and mixtures of at least two of the foregoing, and furthermore

(A) a chelating agent according to general formula (I)

R¹—CH(COOX¹)—N(CH₂COOX¹)₂ (I)

wherein

R¹ is selected from
hydrogen,
C₁-C₄-alkyl, linear or branched, for example methyl, ethyl, n-propyl, iso-propyl, n-butyl, iso-butyl, sec.-butyl, preferred are methyl and iso-butyl and sec.-butyl and even more preferred is methyl,
phenyl, benzyl, CH₂OH, and CH₂CH₂COOX¹, preferred is CH₂CH₂COOX¹.

X¹ is (MₓH₁₋ₓ), M being selected from alkali metal, for example lithium, sodium or potassium or combinations of at least two of the foregoing, preferred are potassium and sodium and combinations of sodium and potassium, and sodium is even more preferred.

x is in the range of from 0.6 to 1, wherein x is an average value. Preferably, x is 1.

(B) a complex of chelating agent according to general formula (I) and of at least one cation selected from Cu²⁺, Mn²⁺, Zn²⁺, Fe²⁺, Fe³⁺, Al³⁺, Cr³⁺, Co²⁺, Ni²⁺, Sn²⁺, Sn⁴⁺, Ti²⁺ and Ti⁴⁺ or a combination of at least two of the foregoing cations,

wherein said formulation contains more organic solvent than water.

In a preferred embodiment, R¹ is methyl, x is 1, and X¹ is selected from potassium and sodium and combinations of sodium and potassium, and preference being given to sodium.

In one embodiment of the present invention, compound of general formula (I) is the racemic mixture. In other embodiments, compound of general formula (I) is selected from the pure enantiomers, for example the L-enantiomer, or mixtures of enantiomers in which one of the enantiomers prevails, preferably the L-enantiomer.

In one embodiment of the present invention, compound of general formula (I) is selected from mixtures of enantiomers containing predominantly the respective L-isomer with an enantiomeric excess (ee) in the range of from 3 to 97%, preferably 20 to 80% and even more preferably 25 to 75%.

In addition, inventive formulations comprise at least one organic solvent selected from alkanols, alkandiols, alkantriols and polyols and mixtures of at least two of the foregoing, preferred are alkandiols and alkantriols and mixtures of at least two of the foregoing, for examples a mixture of two alkandiols, or a mixture of one alkandiol and one alkantriol.

Organic solvents in the context of the present inventions are liquids at ambient temperature and normal pressure. In mixtures of at least two solvents, the respective mixture is liquid at ambient temperature and normal pressure.

Alkanols in the context of the present invention preferably have a boiling point at normal pressure that is higher than the boiling point of water. Examples of suitable alkanols are n-butanol, 2-methyl-1-propanol, 1-pentanol, and 1-hexanol.

Examples of alkandiols are glycol, 1,2-propane diol, diethylene glycol, triethylenglycol, butan-1,2-diol, and 1,3-propandiol.

An example of alkantriols is glycerol.

In a preferred embodiment of the present invention, the at least one organic solvent is selected from ethylene glycol, 1,2-propane diol, glycerol, diethylene glycol, triethylenglycol, polyethylenglycol with an average molecular weight Mₙ of up to 400 g/mol, and polypropylenglycol with an average molecular weight Mₙ of up to 400 g/mol, and mixtures of at least two of the foregoing, for example mixtures from glycerol and at least one out of 1,2-propane diol, diethylene glycol and triethyleneglycol.

Inventive formulations contain more organic solvent than water. In the context of the present invention, the expression “more organic solvent than water” shall refer to the respective weight percentages.

In one embodiment of the present invention, inventive formulations display a dynamic viscosity at 20° C. in the range of from 1,000 to 50,000 mPa·s, preferably 15,000 to 45,000 mPa·s. In one embodiment of the present invention, inventive formulations display a dynamic viscosity at 40° C. in the range of from 1,000 to 50,000 mPa·s, preferably 10,000 to 30,000 mPa·s. In one embodiment of the present invention, inventive formulations display a dynamic viscosity at 80° C. in the range of from 1,000 to 10,000 mPa·s, preferably up to 8,000 mPa·s.

The dynamic viscosity is in each case determined according to Brookfield, in accordance to EN ISO 3219:1994.

In one embodiment of the present invention, inventive formulations have a Hazen color number (APHA) in the range of from 60 to 300.

Inventive formulations may be made according to the inventive process.

Inventive formulations may be used as or for the manufacture of micronutrients, especially in combination with one or more fertilizers. Examples of fertilizers are single nutrient fertilizers and multinutrient fertilizers such as, but not limited to binary fertilizers and NPK fertilizers. Examples of single nutrients fertilizers are nitrogen fertilizers such as, but not limited to urea, ammonium sulfate, calcium ammonium nitrate, and ammonium nitrate, phosphate fertilizers such as super-phosphate, triple superphosphate, and phosphogypsum. Examples of binary fertilizers are NP fertilizers, NK fertilizers, and PK fertilizers. Preferred are NP fertilizers such as monoammonium phosphate and diammonium phosphate.

In one embodiment of the present invention, fertilizer may contain 0.01 to 6% by weight of inventive formulation.

Fertilizer containing inventive formulation may readily be applied to plants or soil according to conventional means, i.e. manually or by machine. Such fertilizer which is also an embodiment of the present invention—can be applied very conveniently, and it fosters plant growth.

The present invention is explained in further detail by the following working examples.

### Working Examples

General: percentages are percent by weight unless expressly stated otherwise. The abbreviation rpm refers to rounds per minute

Colour numbers according to Hazen and Gardner and the iodine values were determined with a Typ LICO® 200, Fa. Dr. Bruno Lange GmbH, apparatus.

The dynamic viscosity was determined in Brookfield Rheometer RVDV-III V EZ Spindel: Brookfield SC4-21. Due to the high viscosities in some cases only one round per minute was chosen instead of the usual 150 rpm. Temperatures: 80° C./60° C./40° C./25° C. (measurements with decreasing temperature), 5 min, with lid. Beaker: Brookfield 13R

### I. Manufacture of Formulations

### I.1 Manufacture of Formulation (F.1)

A 500-ml 4-neck flask was charged with 151 g of a 40% by weight aqueous solution of the trisodium salt of methyl glycine diacetate (MGDA-Na₃). Under stirring with 100 rpm, an amount of 90.5 g of 1,2-propanediol was added in one portion. Then, the majority of the water was removed by distilling it off by rotary evaporation, bath temperature 80° C., 50 mbar, over a time of two hours. A highly viscous solution remained, (F.1). Its properties are summarized in Table 1.

### I.2 Manufacture of Formulation (F.2)

A 500-ml 4-neck flask was charged with 150 g of a 40% by weight aqueous solution of the trisodium salt of methyl glycine diacetate (MGDA-Na₃). Under stirring with 100 rpm, an amount of 73 g of 1,2-propanediol was added in one portion. Then, the majority of the water was removed by distilling it off by rotary evaporation, bath temperature 80° C., 50 mbar, over a time of two hours. A highly viscous solution remained, (F.2). Its properties are summarized in Table 1.

### I.3 Manufacture of Formulation (F.3)

A 500-ml 4-neck flask was charged with 151 g of a 40% by weight aqueous solution of the trisodium salt of methyl glycine diacetate (MGDA-Na₃). Under stirring with 100 rpm, an amount of 90 g diethylene glycol was added in one portion. Then, the majority of the water was removed by distilling it off by rotary evaporation, bath temperature 80° C., 50 mbar, over a time of two hours. A highly viscous solution remained, (F.3). Its properties are summarized in Table 1.

### I.4 Manufacture of Formulation (F.4)

A 500-ml 4-neck flask was charged with 154 g of a 40% by weight aqueous solution of the trisodium salt of methyl glycine diacetate (MGDA-Na₃). Under stirring with 100 rpm 90 g glycerol were added in one portion. Then, the majority of the water was removed by distilling it off by rotary evaporation, bath temperature 80° C., 50 mbar, over a time of two hours. A highly viscous solution remained, (F.4). Its properties are summarized in Table 1.

### I.5 Manufacture of Formulation (F.5)

A 500-ml 4-neck flask was charged with 153 g of a 40% by weight aqueous solution of the trisodium salt of methyl glycine diacetate (MGDA-Na₃). Under stirring with 100 rpm, an amount of 90 g of glycerol was added in one portion. Then, the majority of the water was removed by distilling it off by rotary evaporation, bath temperature 80° C., 50 mbar, over a time of two hours. A highly viscous solution remained, (F.5). Its properties are summarized in Table 1.

### I.6 Manufacture of Formulation (F.6)

A 1000-ml 4-neck flask was charged with 250 g of a 40% by weight aqueous solution of the trisodium salt of methyl glycine diacetate (MGDA-Na₃). Under stirring with 100 rpm, an amount of 150 g of glycerol was added in one portion. Then, the majority of the water was removed by distilling it off by rotary evaporation, bath temperature 80° C., 50 mbar, over a time of two hours. A highly viscous solution remained, (F.6). Its properties are summarized in Table 1.

### I.7 Manufacture of Comparative Formulation C-(F.7)

A 500-ml 4-neck flask was charged with 100 g ethylene glycol and 40 g of a granule of the trisodium salt of methyl glycine diacetate (MGDA-Na₃). The resultant slurry was stirred with 100 rpm at 25° C. over a period of 2 hours. A slurry remained, comparative formulation C-(F.7).

### I.8 Manufacture of Comparative Formulation C-(F.8)

A 100 ml 4-neck flask was charged with 18 g of glycerol and under stirring (100 rpm) 12 g of a granule of the trisodium salt of methyl glycine diacetate (MGDA-Na₃) was added in small portions. The slurry so obtained was stirred at 25° C. over a period of 2 hours. A slurry remained, C-(F.8).

TABLE 1
properties of formulations made according to the inventive
process, and of comparative formulations

| | | | | Concentration | | |
|---|---|---|---|---|---|---|
| | | Water | | MGDA | | |
| Entry | Organic solvent | [wt %] | Appearance | [wt %] | η at 25° C. | η at 40° C. |
| (F.1) | 1,2-propanediol | 3.3 | Clear viscous | 38.5 | >50,000 | 15,950 |
| | | | solution | | | |
| (F.2) | 1,2-propanediol | 2.5 | Clear gel-like | 43.1 | n.d. | >50,000 |
| | | | solution | | | |
| (F.3) | diethylene glycol | 4.6 | Clear viscous | 37.5 | >50,000 | 19,600 |
| | | | solution | | | |
| (F.4) | glycerol | 12.5 | Clear viscous | 37.5 | n.d. | >50,000 |
| | | | solution | | | |
| (F.5) | glycerol | 11.7 | Clear viscous | 37.0 | n.d. | >50,000 |
| | | | solution | | | |
| (F.6) | ethylene glycol | 3.3 | Clear viscous | 40.0 | 9655 | 2395 |
| | | | solution | | | |
| C-(F.7) | ethylene glycol | <3.3 | slurry | 40.0 | n.d. | n.d. |
| C-(F.8) | glycerol | <5 | slurry | 34.5 | n.d. | n.d. |

η: dynamic viscosity, [mPa · s]
n.d.: not determined
A dynamic viscosity η > 50,000 mPa · s denotes that the respective formulation was too viscous for measurement

The water content was determined by Karl-Fischer titration. It is expressed in weight percent.

1. A process for manufacturing a formulation of a chelating agent of formula (I):
R¹—CH(COOX¹)—N(CH₂COOX¹)₂ (I),
wherein:
R¹ is selected from the group consisting of linear C₁-C₄-alkyl, branched C₁-C₄-alkyl, phenyl, benzyl, CH₂OH, and CH₂CH₂COOX¹,
X¹ is (MₓH₁₋ₓ), M being selected from alkali metal,
x is in the range of from 0.6 to 1,
said formulation further comprising from 0.01 to 20% by weight of water, and at least one organic solvent selected from the group consisting of an alkanol with a boiling point at normal pressure that is higher than the boiling point of water, an alkanediol, an alkanetriol, a polyol and mixtures thereof,
the process comprising adding the organic solvent to an aqueous solution of the chelating agent of formula (I), and removing the water completely or a majority of the water by distillation, to obtain the formulation.

2. The process of claim 1, wherein the at least one organic solvent is selected from the group consisting of an alkanediol and an alkanetriol.

3. The process of claim 1, wherein the formulation comprises more of the at least one organic solvent than the water.

4. The process of claim 1, wherein the at least one organic solvent is selected from the group consisting of ethylene glycol, 1,2-propane diol, glycerol, diethylene glycol, triethylene glycol, a polyethylenglycol with an average molecular weight Mₙ of up to 400 g/mol, a polypropylene glycol with an average molecular weight Mₙ of up to 400 g/mol, and mixtures thereof.

5. The process of claim 1, wherein:
M is selected from the group consisting of sodium, potassium, and combinations thereof; and
R¹ is methyl.

6. The process of claim 1, wherein removing of the water is performed at a temperature in the range of from 35 to 100° C. and at a pressure in the range of from 5 to 100,000 hPa.

7. The process of claim 1, wherein the organic solvent is glycerol.

8. The process of claim 1, wherein the adding of the organic solvent, and the removing of the water, are performed under stirring with a speed in the range of from 20 to 400 rounds per minute.

9. The process of claim 1, wherein the formulation further comprises at least one polymer or copolymer.

10. The process of claim 1, wherein the boiling point of the organic solvent added to the aqueous solution is higher than the boiling point of water.

11. The process of claim 1, wherein the water content of the formulation is in the range of from 1 to 15% by weight.

12. The process of claim 1, wherein the formulation further comprises 0.01 to 100 mole-% of at least one cation selected from the group consisting of Cu²⁺, Mn²⁺, Zn²⁺, Fe²⁺, Fe³⁺, Al³⁺, Cr³⁺, Co²⁺, Ni²⁺, Sn²⁺, Sn⁴⁺, Ti²⁺, Ti⁴⁺, and a combination thereof, relative to the chelating agent of formula (I).

13. A formulation, comprising from 0.01 to 20% by weight of water, and at least one organic solvent selected from the group consisting of an alkanol with a boiling point at normal pressure that is higher than the boiling point of water, an alkanediol, an alkanetriol, a polyol, and mixtures thereof, and further comprises:
(A) chelating agent of formula (I):
R¹—CH(COOX¹)—N(CH₂COOX¹)₂ (I),
wherein
R¹ is selected from the group consisting of a linear C₁-C₄-alkyl, a branched C₁-C₄-alkyl, phenyl, benzyl, CH₂OH, and CH₂CH₂COOX¹,
X¹ is (MₓH₁₋ₓ), M being selected from alkali metal, and
x is in the range of from 0.6 to 1;
(B) a complex of the chelating agent of formula (I) and of at least one cation selected from the group consisting of Cu²⁺, Mn²⁺, Zn²⁺, Fe²⁺, Fe³⁺, Al³⁺, Cr³⁺, Co²⁺, Ni²⁺, Sn²⁺, Sn⁴⁺, Ti²⁺, Ti⁴⁺, and combinations thereof,
wherein the formulation comprises more of the at least one organic solvent than the water.

14. A micronutrient, comprising the formulation of claim 13.
